(19) United States
(12) Patent Application Publication
(10) Pub. No.: US 2007/0153830 A1
(43) Pub. Date: Jul. 5, 2007

(54) Methods and apparatus to provide fairness for wireless local area networks that use extended physical layer protection mechanisms

(76) Inventors: Ariton E. Xhafa, Plano, TX (US); Manish Airy, New Delhi (IN); Jin-Meng Ho, Plano, TX (US)

Correspondence Address: TEXAS INSTRUMENTS INCORPORATED, P O BOX 655474, M/S 3999, DALLAS, TX, 75265, US

(21) Appl. No.: 11/584,947

(22) Filed: Oct. 23, 2006

Related U.S. Application Data
(60) Provisional application No. 60/756,469, filed on Jan. 5, 2006.
(60) Provisional application No. 60/757,176, filed on Jan. 6, 2006.

(51) Int. Cl. H04J 3/16

(52) U.S. Cl. 370/470; 370/335

(57) ABSTRACT

Methods and apparatus to provide fairness for wireless local area networks that use extended physical layer (a.k.a. PHY) protection mechanisms are disclosed. A disclosed example method comprises choosing a length field value for a frame header such that, when a transmit operation is ended, a legacy wireless station and a non-legacy wireless station of a wireless local area network are able to start contending for a wireless medium at substantially a same instant, and sending a frame across the wireless medium that includes the frame header.

### RELATED APPLICATIONS

This patent claims priority from U.S. Provisional Application Ser. No. 60/756,469, entitled “Fairness in wireless local area networks that use extended PHY protection mechanism” which was filed on Jan. 5, 2006; and U.S. Provisional Application Ser. No. 60/757,176, entitled “Fairness in wireless local area networks that use extended PHY protection mechanism” which was filed on Jan. 6, 2006. Each of U.S. Provisional Application Ser. Nos. 60/756,469 and 60/757,176 is hereby incorporated by reference in its entirety.

### FIELD OF THE DISCLOSURE

This disclosure relates generally to wireless local area networks (WLANs) and, more particularly, to methods and apparatus to provide fairness for WLANS that use extended physical layer (a.k.a. PHY) protection mechanisms.

### BACKGROUND

Wireless local area networks (WLANs) have evolved to become a popular networking technology of choice for residences, enterprises, commercial and/or retail locations (e.g., hotspots). An example WLAN is based on the Institute of Electrical and Electronics Engineers (IEEE) 802.11x family of standards. Today, the IEEE 802.11x family of standards collectively encompasses a wide range of physical layer technologies, medium access controller (MAC) protocols, and data frame formats.

### BRIEF DESCRIPTION OF THE DRAWINGS

FIG. 1 is a diagram of an example wireless local area network (WLAN) with an access point and a plurality of wireless stations constructed in accordance with the teachings of the invention.

FIG. 2 illustrates an example manner of implementing an example access point and/or an example wireless station of FIG. 1.

FIG. 3 illustrates an example manner of implementing the example medium access controller of FIG. 2.

FIGS. 4A and 4B illustrate an example frame data structure.

FIGS. 5, 6, 7 and 8 illustrate example extended physical layer (a.k.a. PHY) protection scenarios for the example WLAN of FIG. 1.

FIGS. 9, 10 and 11 are flowcharts representative of example machine accessible instructions that may be executed to implement an example access point and/or an example wireless stations of FIG. 1.

### DETAILED DESCRIPTION

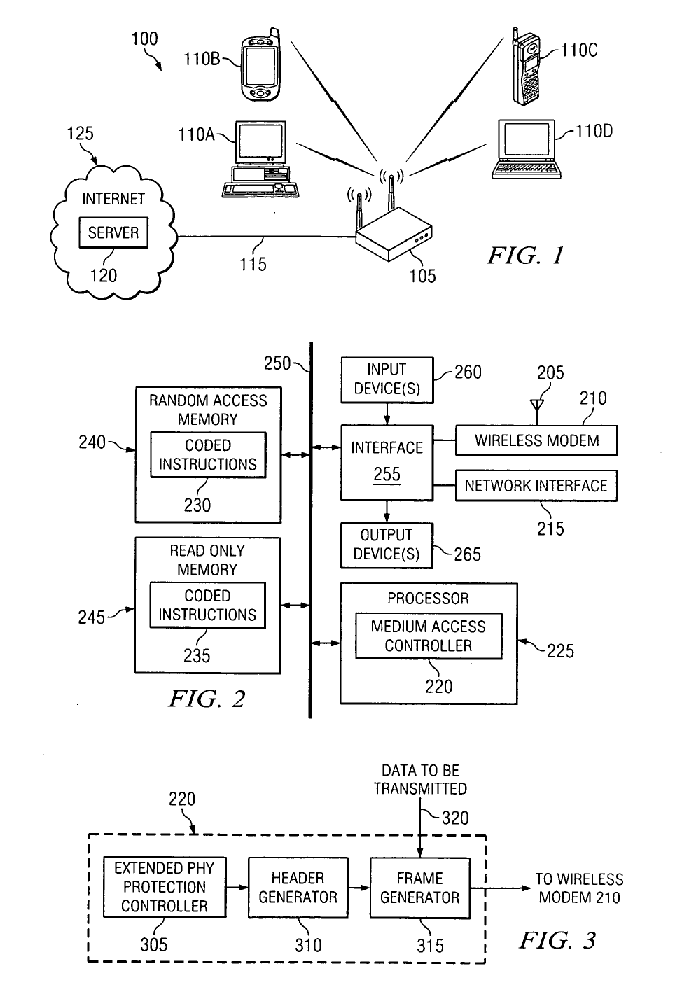

FIG. 1 is a schematic diagram of an example wireless local area network (WLAN) 100. To provide wireless data and/or communication services (e.g., telephone services, Internet services, data services, messaging services, instant messaging services, electronic mail (email) services, chat services, video services, audio services, gaming services, etc.), the example WLAN 100 of FIG. 1 includes an access point (AP) 105 and any of a variety of fixed-location, substantially fixed-location and/or mobile wireless stations (STAs), four of which are respectively designated in FIG. 1 with reference numerals 110A, 110B, 110C and 110D. Example mobile STAs include a personal digital assistant (PDA) 110B, an MP3 player such as an iPod®, a wireless telephone 110C (e.g., a cellular phone, a voice over Internet Protocol (VoIP) phone, a smart phone, etc.), a laptop computer 110D with wireless communication capabilities, etc. Example fixed-location or substantially fixed-location STAs include, for example, any personal computer (PC) 110A with wireless communication capabilities.

The example AP 105 and/or the example STAs 110A-D of FIG. 1 are implemented in accordance with one or more past, present and/or future wired and/or wireless communication standards (e.g., one or more past, present and/or future standards from the Institute of Electrical and Electronics Engineers (IEEE) 802.11x family of standards) and/or implement features from one or more of those standards. Moreover, the AP 105 and/or any of the STAs 110A-D may implement a similar and/or a different set, subset and/or combination of the IEEE 802.11x standards as the AP 105 and/or any of the other STAs 110A-D.

As used herein, a “legacy” STA 110A-D is implemented in accordance with one or more past and/or current wired and/or wireless communication standards such that the STA 110A-D does not necessarily support one or more features of one or more prevailing, present and/or future wired and/or wireless communication standards such as, for example, the IEEE 802.11n standard currently under development. In the example WLAN 100 of FIG. 1, the STAs 110A-D may represent any combination of legacy and/or non-legacy access points and/or wireless stations.

Current proposals for the IEEE 802.11n standard include the ability of an IEEE 801.11n compliant and/or capable AP 105 and/or a STA 110A-D to protect an extended transmission and/or exchange of data. As currently proposed, such STAs 110A-D and/or APs 105 “spoof” legacy STAs 110A-D by setting the legacy length field of a PLCP header to a value that reflects a time period covering more than just a currently transmitting frame, but rather a time period required to transmit two or more frames and any corresponding acknowledgements (i.e., a transmit operation). As defined in one or more past, present and/or prevailing IEEE 802.11x standards, legacy STAs 110A-D upon receipt of a legacy length field of a PLCP header go into a receiving only mode for the duration of the specified time duration. The setting of the PLCP header legacy length field to spoof legacy STAs 110A-D does not interfere with proper operation of currently defined and/or envisioned IEEE 802.11n features and/or capabilities and/or an IEEE 802.11n based wireless network. Such spoofing operation(s), method(s) and/or mechanism(s) are commonly referred to in the industry as “extended physical layer (a.k.a. PHY) protection mechanisms.”

However, currently proposed extended PHY protection mechanisms disadvantage a legacy STA 110A-D because the legacy STA 110A-D has to wait for an extended inter-frame space (EIFS) after the time period elapses while a non-legacy STA 110A-D and/or AP 105 need only wait a distributed inter-frame space (DIFS) or an arbitrary inter-frame space (AIFS) traffic access category (AIFS[AC]) before contending for the communication medium, where DIFS <EIFS and AIFS[AC]<EIFS. For ease of explantion, throughout the following descriptions, references will only be made to waiting a DIFS, however, persons of ordinary skill in the art will readily appreciate that the STA 110A-D and/or AP 105 need only wait a DIFS or an AIFS[AC] before contending for the communication medium. Accordingly, legacy STAs 110A-D cannot begin contending for the wireless medium (i.e., start a contention window) at substantially the same instant as non-legacy STAs 110D and/or the AP 105, thereby causing legacy STAs 110A-D to suffer a disadvantage in obtaining access to the wireless medium. Moreover, legacy STAs 110A-D are particularly disadvantaged when an initiated transmit operation fails to complete. In such circumstances, the non-legacy STA 110A-D can begin contending much earlier than legacy STAs 110A-D which cannot contend until the scheduled period for the failed transmit operation completes. The example AP 105 and/or the example STAs 110A-D of FIG. 1 implement apparatus, methods and/or mechanisms to set PLCP legacy length field values such that legacy and/or non-legacy STAs 110A-D and/or APs 105 can start a contention window (i.e., begin contending for a wireless medium) at substantially the same instant.

In the example of FIG. 1, to allow the plurality of STAs 110A-D to communicate with devices and/or servers located outside the example WLAN 100, the example AP 105 is communicatively coupled via any of a variety of communication paths 115 to, for example, any of a variety of servers 120 associated with one or more public and/or private network(s) such as the Internet 125. The example server 120 may be used to provide, receive and/or deliver, for example, any variety of data, video, audio, telephone, gaming, Internet, messaging and/or electronic mail service. Additionally or alternatively, the example WLAN 100 of FIG. 1 may be communicatively coupled to any of a variety of public, private and/or enterprise communication network(s), computer(s), workstation(s) and/or server(s) to provide any of a variety of voice service(s), data service(s) and/or communication service(s) including, for example, any of the services mentioned in the previous sentence.

While a single AP 105 is illustrated in the example of FIG. 1, persons of ordinary skill in the art will readily appreciate that the example WLAN 100 could include one or more of any of a variety of APs 105. For example, to provide wireless data and/or communication services over a site, location, building, geographic area and/or geographic region, a plurality of communicatively coupled APs 105 could be utilized. For instance, a plurality of APs 105 could be arranged in a pattern and/or grid with abutting and/or overlapping coverage areas such that any STA(s) 110A-D located in, and/or moving through and/or within an area communicatively covered by one or more of the plurality of APs 105 can communicate with at least one of the APs 105.

While this disclosure refers to the example WLAN 100, the example AP 105 and/or the example STAs 110A-D of FIG. 1, the example WLAN 100 of FIG. 1 may be used to provide services to, from and/or between any alternative and/or additional wired and/or wireless communication devices (e.g., telephone devices, personal digital assistants (PDA), laptops, etc.). Additionally, although for purposes of explanation, this disclosure refers to the example WLAN 100, the example AP 105 and/or the example STAs 110A-D illustrated in FIG. 1, any additional and/or alternative variety and/or number of communication systems, communication devices and/or communication paths may be used to implement a WLAN and/or to provide data and/or communication services. Moreover, while this disclosure references the IEEE 802.11x family of standards and/or extended PHY protection mechanisms and/or methods proposed for the IEEE 802.11n standard, persons of ordinary skill in the art will appreciated that the methods and apparatus disclosed herein may be utilized for wireless networks operated in accordance with any of a variety of standards such as, for example, the IEEE 801.16x (a.k.a. WiMax) family of standards, to ensure legacy and/or non-legacy STAs 110A-D have fair access to a wireless medium at the end of an ongoing transmit operation.

Similarly, while for purposes of illustration, this disclosure references performing extended PHY protection mechanisms and/or beginning wireless medium contention following extended PHY protection mechanisms for the example WLAN 100 of FIG. 1, persons of ordinary skill in the art will readily appreciate that the methods and apparatus disclosed herein may additionally or alternatively be applied to any type of network access control protocol(s), any type of wired and/or wireless communication system(s), and/or any type of network(s), and/or any of a variety of WLAN standards and/or specifications.

FIG. 2 illustrates an example manner of implementing the example AP 105 and/or any of the example STAs 110A-D of FIG. 1. However, while FIG. 2 can represent the example AP 105 and/or one or more of the example STAs 110A-D, for ease of discussion, in the following the example device of FIG. 2 will be referred to as an AP/STA to make clear that the device may be either an AP 105 and/or a STA 110A-D.

To support wireless communications with the example AP 105 and/or one or more of the example STAs 110A-D of the example WLAN 100 of FIG. 1, the example AP/STA of FIG. 2 includes any of a variety of radio frequency (RF) antennas 205 and any of a variety of physical-layer wireless modems 210. The example RF antenna 205 and the example wireless modem 210 of FIG. 2 are able to receive, demodulate and decode WLAN signals transmitted to and/or within the example WLAN 100 of FIG. 1. Likewise, the wireless modem 210 and the RF antenna 205 are able to encode, modulate and transmit WLAN signals from the example AP/STA to the example AP 105 and/or any or all of the example STAs 110A-D of the example WLAN 100 of FIG. 1. Thus, as commonly referred to in the industry, the example RF antenna 205 and the example wireless modem 210 collectively implement the PHY for the example AP/STA of FIG. 2.

To communicatively couple the example AP/STA of FIG. 2 to another device and/or network (e.g., a local area network (LAN), the Internet 125, etc.), the example AP/STA of FIG. 2 includes any of a variety of network interfaces 215. The example network interface 215 of FIG. 2 operates in accordance with any of the IEEE 802.3x (a.k.a. Ethernet) family of standards.

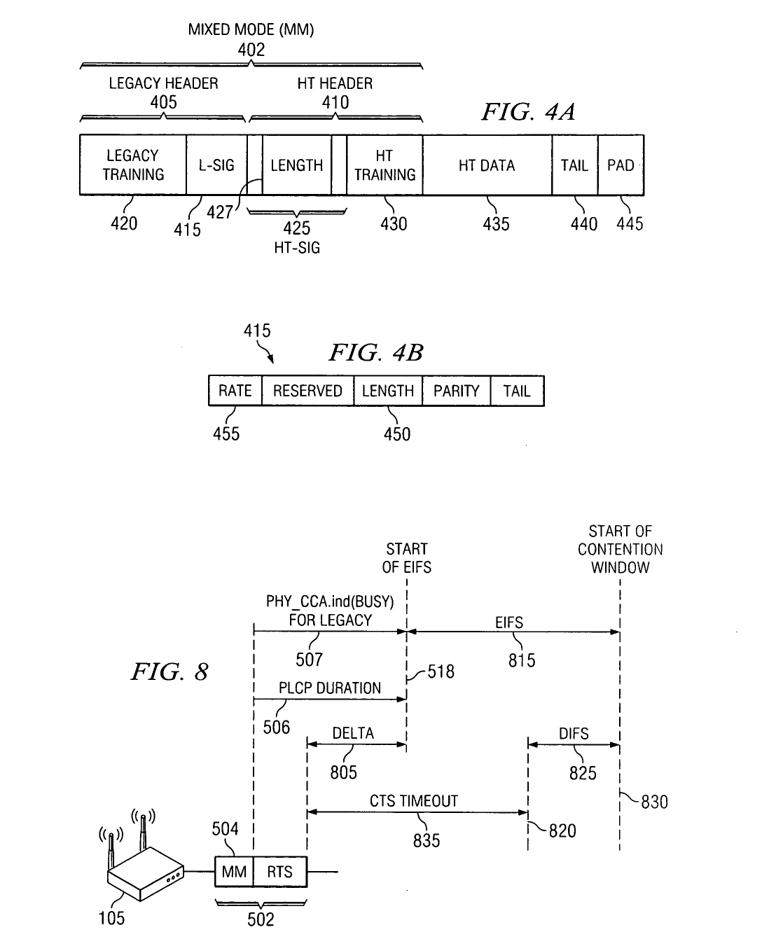

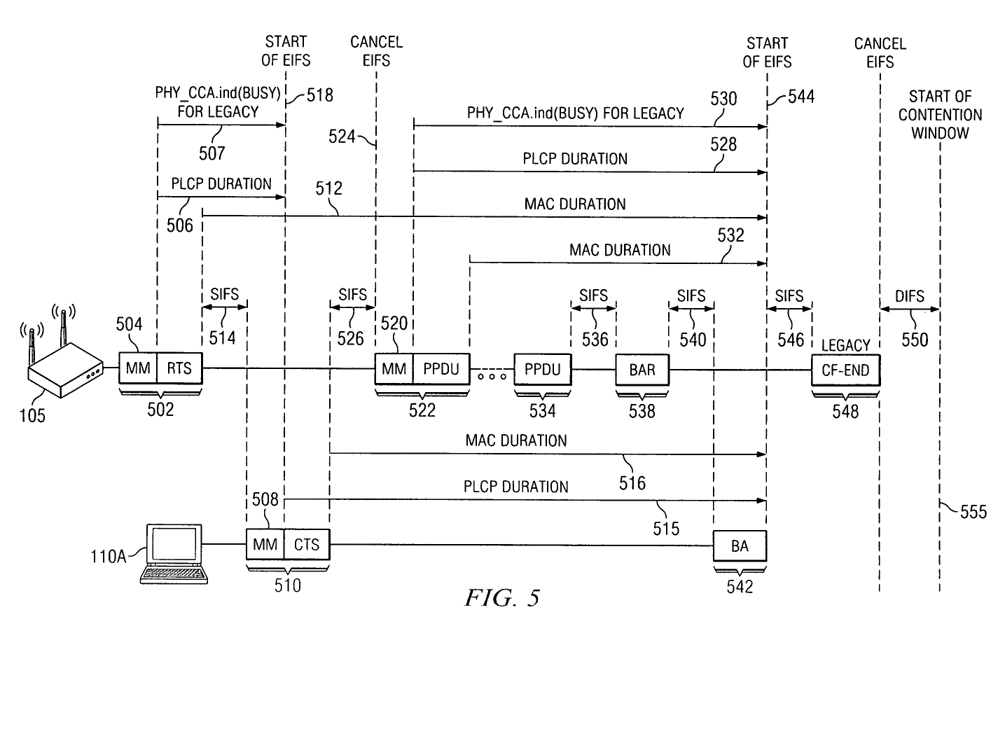

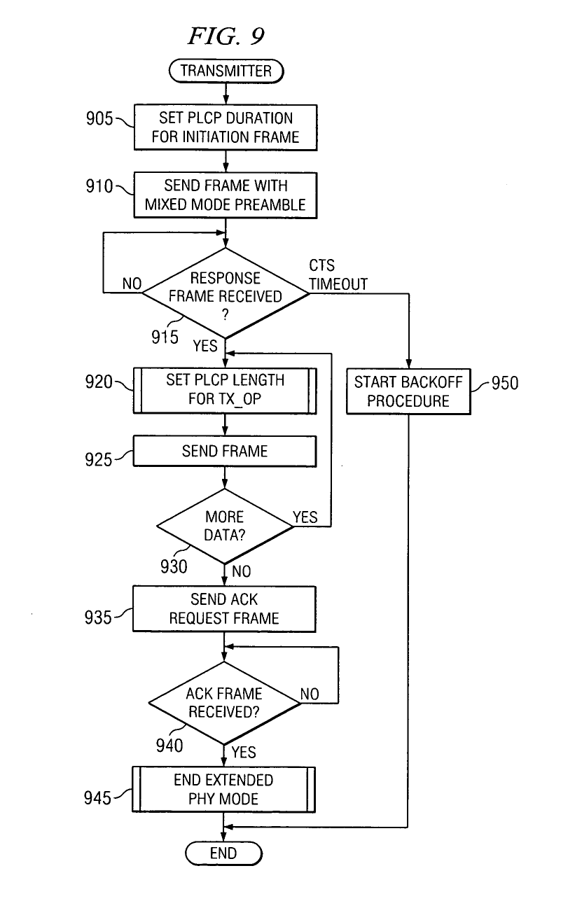

To provide medium access controller (MAC) functionality, the example AP/STA of FIG. 2 includes a MAC 220. In addition to MAC functions, the example MAC 220 of FIG. 2 implements, executes and/or carries out functionality to facilitate, direct and/or ensure fair wireless medium access following extended PHY protection mechanisms for the example WLAN 100 of FIG. 1. Example methods of implementing the example MAC 220 are discussed below in connection with FIGS. 3-11. In particular, FIG. 3 illustrates an example manner of implementing the example MAC 220. FIGS. 4A and 4B illustrate an example PLCP frame. FIGS. 5-8 illustrate example extended PHY protection mechanism scenarios implemented in accordance with the teachings of the invention. FIGS. 9-11 illustrate example machine executable instructions that may be carried out to implement the example AP/STA of FIG. 2 and/or to carry out the example scenarios of FIGS. 5, 6, 7 and/or 8.

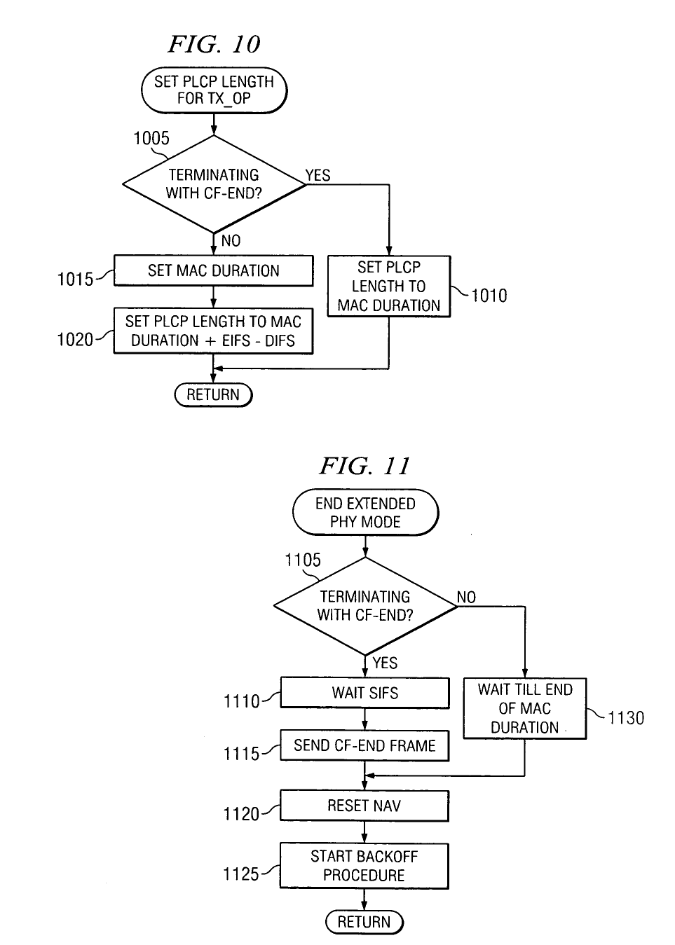

To implement the example MAC 220 using one or more of any of a variety of software, firmware, processing thread(s) and/or subroutine(s), the example AP/STA of FIG. 2 includes a processor 225. The example processor 225 of FIG. 2 may be one or more of any of a variety of processors such as, for example, a microprocessor, a microcontroller, a digital signal processor (DSP), an advanced reduced instruction set computing (RISC) machine (ARM) processor, etc. The example processor 225 executes coded instructions 230 and/or 235 which may be present in a main memory of the processor 225 (e.g., within a random-access memory (RAM) 240 and/or a read-only memory (ROM) 245) and/or within an on-board memory of the processor 225. The example processor 225 may carry out, among other things, the example machine accessible instructions illustrated in FIGS. 9, 10 and/or 11 to implement the example MAC 220.

While in the illustrated example of FIG. 2, the example MAC 220 is implemented by executing one or more of a variety of software, firmware, processing thread(s) and/or subroutine(s) with the example processor 225, the example MAC 220 of FIG. 2 may be, additionally or alternatively, implemented using any of a variety of application specific integrated circuit(s) (ASIC(s)), programmable logic device(s) (PLD(s)), field programmable logic device(s) (FPLD(s)), discrete logic, hardware, firmware, etc. Also, some or all of the example MAC 220 may be implemented manually or as any combination of any of the foregoing techniques, for example, the MAC 220 may be implemented by any combination of firmware, software and/or hardware.

The processor 225 is in communication with the main memory (including the RAM 240 and the ROM 245) via a bus 250. The example RAM 240 may be implemented by DRAM, SDRAM, and/or any other type of RAM device. The example ROM 245 may be implemented by flash memory and/or any other desired type of memory device. Access to the memories 240 and 245 is typically controlled by a memory controller (not shown). The RAM 240 may be used, for example, to store the wireless medium access contention information, data and/or parameters. One such example parameter is a network access vector (NAV) and/or a PHY_CCA.ind (i.e., PHY layer clear channel assessment indicator) which may be used by the example AP/STA of FIG. 2 for wireless medium access control, to facilitate wireless medium reservations, and/or to reduce and/or manage network congestion. The NAV and/or the PHY_CCA.ind may be implemented by, for example, a countdown timer that can be used to determine when bandwidth of the example WLAN 100 is available for use by the example AP/STA.

The example AP/STA of FIG. 2 also includes any of a variety of interface circuits 255. The example interface circuit 255 of FIG. 2 may implement any of a variety of interfaces, such as external memory interface(s), serial port(s), general purpose input/output port(s), etc. Additionally or alternatively, the interface circuit 255 may communicatively couple the example wireless modem 210 and/or the network interface 215 with the processor 225 and/or the example MAC 220.

In the example of FIG. 2, any of a variety of input devices 260 and any of a variety of output devices 265 are connected to the interface circuit 255. Example input devices 260 include a keyboard, touchpad, buttons and/or keypads, etc. Example output devices 265 include a display (e.g., a liquid crystal display (LCD)), a screen, a light emitting diode (LED), etc.

While an example manner of implementing the example AT/STA is illustrated in FIG. 2, the AP/STA may be implemented using any of a variety of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 2 may be combined, divided, re-arranged, eliminated and/or implemented in any of a variety of ways. Additionally, the example interface 255, the example wireless modem 210, the example network interface 215, the example MAC 220 and/or, more generally, the example AP/STA of FIG. 2 may be implemented as any combination of firmware, software, logic and/or hardware. Moreover, the example AP/STA may include additional processor(s), device(s), component(s), circuit(s), interface(s) and/or module(s) than those illustrated in FIG. 2 and/or may include more than one of any or all of the illustrated processor(s), device(s), component(s), circuit(s), interface(s) and/or module(s).

FIG. 3 illustrates an example manner of implementing the example MAC 220 of FIG. 2. To control and/or set the length of an extended PHY protection mechanism, the example MAC 220 of FIG. 3 includes an extended PHY protection controller 305. The example extended PHY protection controller 305 of FIG. 3 determines and/or estimates the duration of all and/or any portion of a transmit operation that will utilize an extended PHY protection mechanism. Based upon the duration, the example extended PHY protection controller 305 determines a MAC duration and/or a legacy PLCP length that are included in a header of a frame sent during initiation of the transmit operation and/or during the transmit operation itself. As discussed below in connection with FIGS. 5-8, the example extended PHY protection controller 305 need not set the MAC duration and the legacy PLCP length to the same values. In fact, the example MAC 220 of FIGS. 2 and/or 3, and/or, more particularly, the example extended PHY protection controller 305 sets the MAC duration and the legacy PLCP length to different values to ensure that legacy STAs 110A-D have fair access to the wireless medium following a transmit operation.

To generate headers for frames being transmitted, the example MAC 220 of FIG. 3 includes a header generator 310. The example header generator 310 of FIG. 3 creates frame headers in accordance with any of a variety of past, present and/or future standard(s) and/or specification(s) such as the IEEE 802.11x family of standards. Example headers are discussed below in connection with FIGS. 4A and 4B.

To generate frames for transmission, the example MAC 220 of FIG. 3 includes a frame generator 315. The example frame generator 315 of FIG. 3 forms any of a variety of frames such as request-to-send (RTS) frames, clear-to-send (CTS) frames, aggregate PLCP protocol data unit (PPDU) frames, contention-free end (CF-END) frames, block acknowledge request (BAR) frames, block acknowledge (BA) frames, etc. based upon headers generated by the example header generator 310 and/or data to be transmitted 320 and/or in accordance with any of a variety of past, present and/or future standard and/or specification such as the IEEE 802.11x family of standards.

While an example MAC 220 is illustrated in FIG. 3, the MAC 220 may be implemented using any of a variety of other and/or additional processors, devices, components, circuits, modules, interfaces, etc. Further, the processors, devices, components, circuits, modules, elements, interfaces, etc. illustrated in FIG. 3 may be combined, re-arranged, eliminated and/or implemented in any of a variety of ways. Additionally, the example extended PHY protection controller 305, the example header generator 310, the example frame generator 315 and/or, more generally, the example MAC 220 may be implemented as any combination of firmware, software, logic and/or hardware. Moreover, the example MAC 220 may include additional processors, devices, components, circuits, interfaces and/or modules than those illustrated in FIG. 3 and/or may include more than one of any or all of the illustrated processors, devices, components, circuits, interfaces and/or modules.

FIG. 4A illustrates an example transmit frame constructed in accordance with the IEEE 802.11x family of standards and that includes a mixed-mode (MM) preamble 402 containing a legacy header 405 and a high-throughput (HT) header 410. To convey and/or contain information, parameters and/or data useful to a legacy STA 110A-D such as, for example, a PLCP length used to spoof a legacy STA I 10A-D concerning the length of extended PHY protection mechanism, the example legacy header 405 of FIG. 4A includes a Legacy Signal (L-SIG) field 415. An example L-SIG field 415 is discussed below in connection with FIG. 4B. Upon correct receipt of the L-SIG field 415, a legacy STA 110A-D sets its PHY_CCA.ind busy duration based upon the PLCP length contained in the L-SIG field 415.

To provide one or more training signals and/or symbols to facilitate training of a receiver, the example legacy header 405 of FIG. 4A includes a legacy training field 420. The example legacy training field 420 of FIG. 4A includes a short training sequence and/or a long training sequence (not shown) that allow a receiver to synchronize to the legacy header 405. Example legacy training fields 420, short training sequences and/or long training sequences are those defined by any of a variety of past, present and/or future standard(s) and/or specification(s) such as the IEEE 802.11x family of standards. By synchronizing to the legacy training signal(s) and/or symbol(s) 420, a receiver is able to correctly receive and/or decode the example L-SIG field 415.

To convey and/or contain information, parameters and/or data useful to a HT STA 110A-D (e.g., a STA 110A-D operating in accordance with the proposed IEEE 802.11n standard), the example HT header 410 of FIG. 4A includes a HT Signal (HT-SIG) field 425. The example HT-SIG field 425 of FIG. 4A includes, among other things, a MAC duration sub-field 427 used by a transmitter to set the duration of an extended PHY protection mechanism for non-legacy STAs 110A-D. In the illustrated example, upon correct receipt of the HT-SIG field 425, a HT STA 110A-D sets and/or updates its NAV based upon the MAC duration such as, the MAC length sub-field 427.

To provide one or more training signals and/or symbols to facilitate training of a receiver, the example HT header 410 of FIG. 4A includes a HT training field 430. The example HT training field 430 of FIG. 4A includes a HT short training sequence and/or a HT long training sequence (not shown) that allows a receiver to synchronize to HT data 435 that follows the example MM preamble 402. Example HT training fields 430, HT short training sequences and/or HT long training sequences are those defined by any of a variety of past, present and/or future standard(s) and/or specification(s) such as the proposed IEEE 802.11n standard. By synchronizing to the HT training signal(s) and/or symbol(s) 430, a receiver is able to correctly receive and/or decode the data contained in the HT data field 435.

In the example of FIG. 4A, the example HT data 435 is formatted and/or constructed in accordance variety of past, present and/or future standard and/or specification such as the proposed IEEE 802.11n standard.

To ramp down a convolutional code applied to the example data 435, the example frame of FIG. 4A includes a tail 440 field. The example tail field 440 of FIG. 4A is six (6) bits in length as defined by the IEEE 802.11n standard. To pad the overall length of the example frame of FIG. 4A, the example frame of FIG. 4A includes a pad field 445. The length of the example pad field 445 of FIG. 4A is chosen to pad the overall length of the example frame to equal an integer multiple of the symbol block size being utilized.

FIG. 4B illustrates the example L-SIG field 415 of FIG. 4A in more detail. To convey a PLCP length, the example L-SIG field 415 of FIG. 4B includes a legacy length field 450. In the examples of FIGS. 5-8, the example legacy length field 450 of FIG. 4B is used to convey the length of an extended PHY protected mechanism to legacy STAs 110A-D. Example methods to select and/or determine the values for the example legacy length field 450 are discussed below in connection with FIGS. 5-11.

To convey the transmission rate for an extended PHY protection mechanism, the example L-SIG field 415 of FIG. 4B includes a rate field 455. In the illustrated example, the value contained in the example rate field 455 of FIG. 4B is set to a low value (e.g., six (6) Million bits-per-second (Mbps)). A legacy STA 110A-D uses the value in the example legacy length field 450 and the example rate field 455 to estimate the approximate transmission time duration for a transmit operation.

Persons of ordinary skill in the art will readily recognize that the example frame illustrated in FIGS. 4A and 4B can represent any of a variety of frames such as, for example, the RTS, CTS, CF-END, BA, BAR and/or aggregate PPDU frames defined by the IEEE 802.11x family of standards. Moreover, while an example frame data structure is illustrated in FIGS. 4A and 4B, persons of ordinary skill in the art will readily recognize that any of a variety of other data structures may be used to construct a frame. In particular, the example legacy headers 405, the example HT header 410 and/or the example L-SIG field 415 may include and/or be constructed using any of a variety of other and/or additional fields and/or data. Further, the fields and/or data illustrated in FIGS. 4A and/or 4B may be combined, divided, re-arranged, eliminated and/or implemented in any of a variety of ways. Moreover, the example data structures of FIGS. 4A and/or 4B may include additional fields and/or data than those illustrated in FIGS. 4A and/or 4B and/or may include more than one of any or all of the illustrated fields and/or data.

FIGS. 5, 6, 7 and 8 illustrate example extended PHY protection mechanism scenarios constructed in accordance with teachings of the invention for the example WLAN 100 of FIG. 1. While the example scenarios of FIGS. 5, 6, 7 and/or 8 can represent the operation(s) of any of the example STAs 110A-D of FIG. 1, for ease of discussion, the example wireless station illustrated in FIGS. 5-8 will simply be referred to as STA 110A.

In the examples of FIGS. 5-8, the AP 105 initiates a transmit operation to the example STA 110A utilizing an extended PHY protection mechanism. To this end, in the illustrated examples, the AP 105 selects, determines and/or sets legacy PLCP length values and MAC duration values such that legacy and/or non-legacy STAs 110A-D, and/or the AP 105 can begin contending for the wireless medium (i.e., start a contention windows) at substantially the same time. While in the example transmit operations of FIGS. 5-8, the AP 105 transmits data to the STA 110A, persons of ordinary skill in the art will recognize that the methods of setting extended PHY protection mechanism durations for legacy and/or non-legacy STAs 110A-D and/or the AP 105 illustrated in FIGS. 5-8 may be used for any of a variety of transmit operations such as, transmitting data from the STA 110A to one or more of the STAs 110B-D, from any of the STAs 110A-D to the AP 105, etc.

Turning to FIG. 5 in more detail, to initiate a transmit operation (TxOP) for which an extended PHY protection mechanism will be used, the example AP 105 of FIG. 5 broadcasts an RTS frame 502. To set the legacy and non-legacy durations for the transmit operation, the example RTS frame 502 of FIG. 5 includes a MM preamble 504 (e.g., the example MM preamble 402 of FIG. 4A). The example MM preamble 504 of FIG. 5 includes a legacy PLCP length and rate (e.g., the example fields 450 and 455 of FIG. 4B) that collectively represent a PLCP duration 506 that covers the transmission of a header 508 of a subsequent CTS frame 510. The example MM preamble 504 also includes a MAC duration (e.g., the example MAC length 427 of FIG. 4A) that represents the duration of the entire transmit operation being initiated as illustrated in FIG. 5 with reference numeral 512. Upon receipt of the PLCP duration 506, legacy STAs 110A-D set their PHY_CCA.ind busy duration 507 equal to the PLCP duration 506 as illustrated in FIG. 5. Accordingly, until the end of the PHY_CCA.ind duration 507, legacy STAs 110A-D may not transmit signals. As illustrated in FIG. 5, PLCP durations are referenced to ends of MM preambles, while MAC durations are referenced to ends of frames.

As will be discussed in more detail in FIG. 8, by setting the legacy PLCP duration 506 of the example RTS frame 502 to include the MM preamble 508 of the CTS frame 510, legacy and/or non-legacy STAs 110A-D and/or the AP 105 can begin contending for the wireless medium at substantially the same time if the transmit operation fails to be correctly initiated (e.g., the CTS frame 510 is not transmitted by the STA 110A). However, based upon any of a variety of additional and/or alternative criteria and/or algorithms, the legacy PLP duration 506 of the RTS frame 502 could be set to other durations including, for example, to only the length of the RTS frame 502, to the combined length of the RTS frame 502 and the CTS frame 510, to the length of the entire transmit operation, etc. Since, at least the legacy portion of the example MM preamble 504 (e.g., the example legacy header 405 of FIG. 4A) can be received by legacy STAs 110A-D, the remainder of the MM preamble 504 and/or the RTS frame 302 may be sent using a format consistent with any non-legacy transmission technology(-ies) and/or non-legacy transmission rate(s) such as those proposed for the IEEE 802.11x standard.

After receiving the RTS frame 502, the example STA 110A of FIG. 5 waits a time interval 514 having a duration of at least the Short InterFrame Space (SIFS) and then sends the CTS frame 510. Like the RTS frame 502, the example CTS frame 510 of FIG. 3 includes a MM preamble 508 that includes a legacy PLCP length and rate (e.g., the example fields 450 and 455 of FIG. 4B) that represent a PLCP duration 515 that covers the remainder of the entire transmit operation, and a MAC duration 516 (e.g., the example MAC duration 427 of FIG. 4A) that covers the remainder of the entire transmit operation.

While not illustrated in FIG. 5, if a legacy STA 110A-D does correctly receive the legacy portion of the MM preamble 508, the legacy STA 110A-D may set and/or updates its PHY_CCA.ind busy duration based on the legacy PLCP length 515.

Upon receipt of the MM preamble 508, non-legacy STAs 110A-D update and/or set their NAV based on the MAC duration 516 of the MM preamble 508. Alternatively, if a non-legacy STA 110A-D is not able to correctly decode the MAC duration 516, it may update and/or set its NAV based upon the legacy PLCP duration 515.

At the end of the PHY_CCA.ind duration 507 at instant 518, a legacy STA 110A-D starts a time interval having a duration of at least an extended inter-frame space (EIFS). However, upon receipt of the MM preamble 520 of an example frame 522, the legacy STA 110A-D cancels and/or terminates the EIFS interval as illustrated with reference numeral 524.

After receiving the CTS frame 510 and waiting a time interval 526 having a duration of at least the SIFS, the AP 105 of the illustrated example sends a first frame 522, for example, any of a variety of aggregate PPDU frames using any transmission technique(s) and/or transmission rate(s) such as a technique and/or rate in accordance with the IEEE 802.11n standard. As discussed above in connection with FIGS. 4A and 4B, the example PPDU frame 522 of FIG. 5 includes an L-SIG field (e.g., the example L-SIG field 415 of FIG. 4A) in the MM preamble 520 that is receivable by legacy STAs 110A-D. The L-SIG field contains a legacy PLCP length and rate that represent a PLCP duration 528. Legacy STAs 110A-D use the PLCP duration 528 to set and/or update their PHY_CCA.ind busy duration 530 as illustrated in FIG. 5. Likewise, the example PPDU frame 522 of FIG. 5 contains a MAC duration 532 that non-legacy STAs 110A-D may use to set and/or update their NAVs.

The process of sending frames (e.g., PPDU frames) separated by time intervals having durations of at least the SIFS continues until the AP 105 reaches a last data frame 534. While not illustrated in FIG. 5, when each frame is received by a non-legacy STA 110A-D, the non-legacy STA 110A-D updates and/or sets its NAV based upon the MAC duration contained in a MM and/or HT preamble associated with the frame.

In the example of FIG. 5, after sending the last frame 534 and waiting a time interval 536 having a duration of at least the SIFS, the AP 105 of the illustrated example sends a BAR frame 538 using any transmission technique(s) and/or transmission rate(s) such as a technique and/or rate in accordance with the IEEE 802.11n standard.

After receiving the BAR frame 538 and waiting a time interval 540 having a duration of at least the SIFS, the STA 110A of the illustrated example sends a BA frame 542 using any transmission technique(s) and/or transmission rate(s) such as a technique and/or rate in accordance with the IEEE 802.11n standard.

At a time instant 544 that substantially matches the end of the example BA frame 542, the MAC durations 516 and 532, and the PHY_CCA.ind busy duration 530 expire. Accordingly, at the example instant 544 of FIG. 5, legacy STAs 110A-D start a time interval having a duration of at least the EIFS.

After receiving the BA frame 542 and waiting a time interval 546 having a duration of at least the SIFS, the AP 105 of the illustrated example sends a CF-END frame 548. Because the example CF-END frame 548 is transmitted such that legacy STAs 110A-D can receive and/or verify the CF-END frame 548, a legacy STA 110A-D that correctly receives the CF-END frame 548 can terminate its EIFS interval substantially coincident with the end of the CF-END frame 548 as illustrated in FIG. 5. Then, after waiting a time interval 550 having a duration of at least the DIFS, such legacy STAs 110A-D can begin contending for the wireless medium (i.e., start a contention window) at approximately a moment 555 as illustrated in FIG. 5. However, if the legacy STA 110A-D is: a) not able to hear the CF-END frame 548 or b) receives the CF-END frame 548 in error and starts a new EIFS at the end of the CF-END frame 548 reception;, the legacy STA 110A-D may start a contention window at the end of its EIFS interval.

Upon the end of its MAC duration and/or upon receipt of the example CF-END frame 548, non-legacy STAs 110A-D and/or the AP 105 likewise wait a time interval 550 having a duration of at least the DIFS, and then begin contending for the wireless medium at substantially the same moment 555 as the legacy STAs 110-D begin contending for the wireless medium.

While the example transmit operation of FIG. 5 includes transmitting aggregate PPDU frames, a BAR frame and a BA frame, transmit operations can include any of a variety and/or sequence of frames. In some examples, a BA frame may be sent in response to each aggregate PPDU frame. In other examples, any combination of aggregate and/or single PPDU frames are transmitted. As discussed below in connection with FIG. 8, persons of ordinary skill in the art will readily recognize that an extended PHY protection mechanism can include a single frame (e.g., the example RTS frame 502). Persons of ordinary skill in the art will also readily appreciate that the methods and apparatus described herein for setting legacy PLCP durations and MAC durations for extended PHY protection mechanisms can be used for any of a variety of transmit operations.

If the example transmit operation of FIG. 5 had been initiated by the example STA 110A, the example CF-END frame 548 could be transmitted by the STA 110A and/or the AP 105. If the former, it is possible that the CF-END frame 548 might not be received by a hidden node such that some legacy STAs 110A-D may not cancel their EIFS interval at the end of the CF-END frame. In some examples, the example AP 105 of FIG. 5 sends the CF-END frame 548 regardless of who initiates the transmit operation, and/or regardless of whether or not the AP 105 is involved in the transmit operation (e.g., the transmit operation is between two STAs 110A-D).

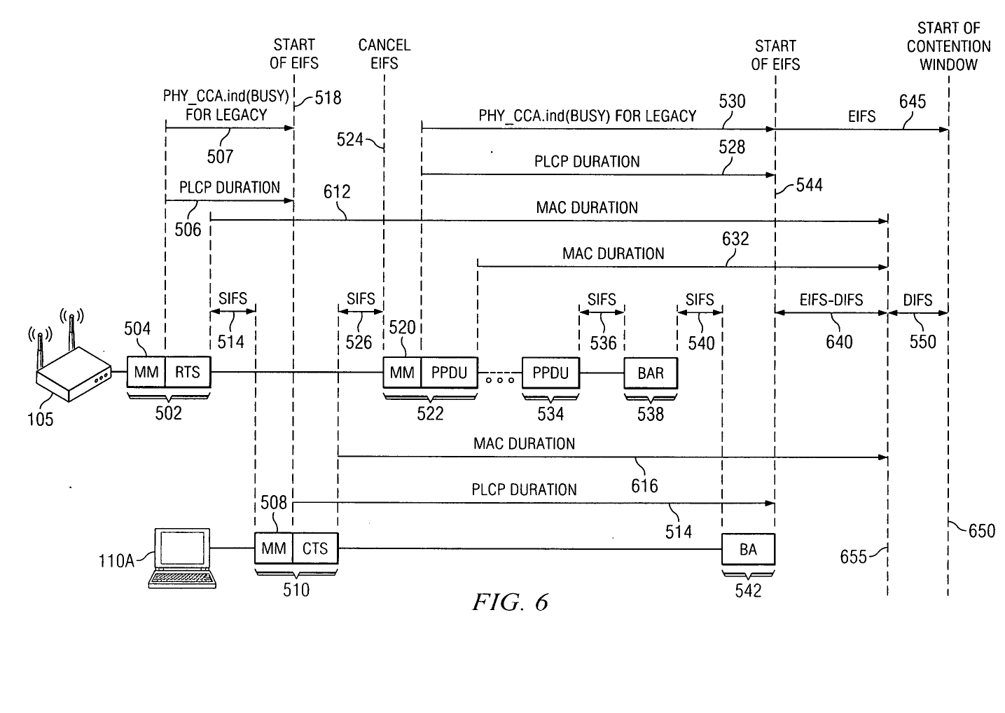

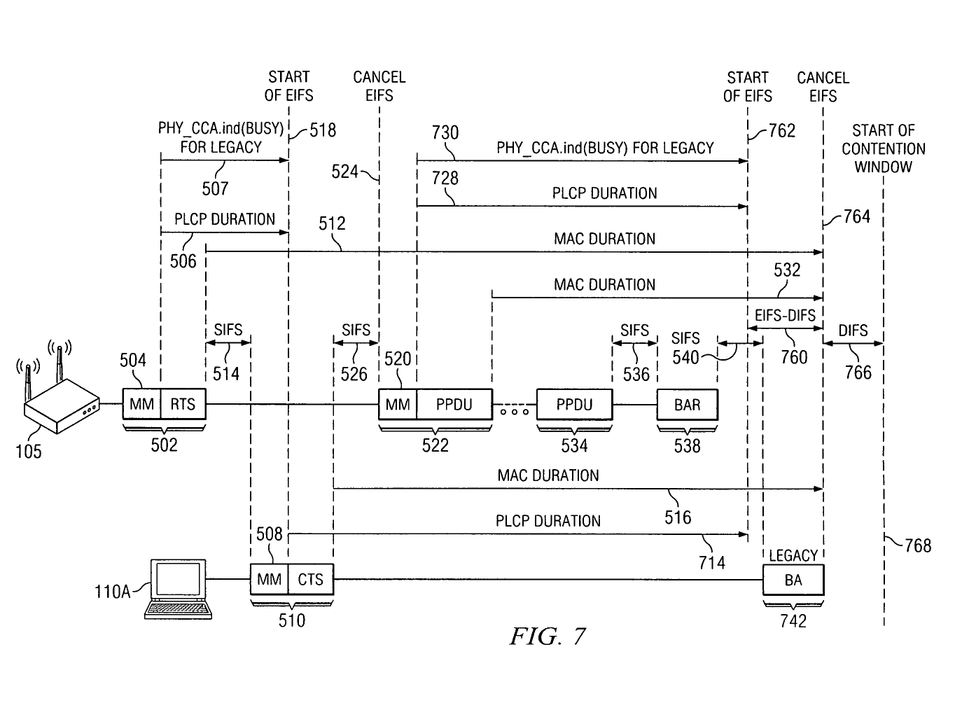

Because the first portions of the example scenarios of FIG. 6 and 7 is identical to that discussed above in connection with FIG. 5, the description of the first portions is not repeated here. Instead, identical frames and time intervals are illustrated with identical reference numerals in FIGS. 5, 6 and 7, and the interested reader is referred back to the descriptions presented above in connection with FIG. 5 for a complete description of those like numbered frames and time intervals.

Turning to FIG. 6 in more detail, the example MAC durations 612, 616 and 632 of FIG. 6 are set by the example AP 105 to durations that are longer than the example MAC durations 512, 516 and 532 of FIG. 5, respectively. As compared to FIG. 5, the example MAC durations 612, 616 and 632 of FIG. 6 are longer by the difference 640 between EIFS and DIFS. Accordingly, the example MAC durations 612, 616 and 632 extend beyond the example transmit operation as illustrated in FIG. 6 (i.e., beyond the time 544) and, thus, the example CF-END frame 548 need not be transmitted by the AP 105.

Like the example of FIG. 5, at the example time instant 544, legacy STAs 110A-D start a time interval 645 having a duration of at least the EIFS. Because the example AP 105 of FIG. 6 does not send the example CF-END frame 548 of FIG. 5, the interval 645 expires at an example instant 650, and legacy STAs 110A-D can begin contending for the wireless medium (i.e., start a contention window) at time 650.

When the MAC durations 612, 616, 632 expire (e.g., at a time instant 655), non-legacy STAs 110A-D and/or the AP 105 wait the example time interval 550 having a duration of at least the DIFS, and then begin contending for the wireless medium (i.e., start a contention window) at substantially the same moment 650 as the legacy STAs 110-D begin contending for the wireless medium.

Turning to FIG. 7, the example PLCP durations 714 and 728 of FIG. 7 are set to durations that are shorter than the example MAC durations 516 and 532, respectively. In the illustrated example, the PLCP durations 714, 728 are shorter by a difference 760 between EIFS and DIFS.

Accordingly, the PHY_CCA.ind busy duration 730 is shorter than the example PHY_CCA.ind busy duration 530 of FIG. 5 by the difference 740 between EIFS and DIFS or AIFS[AC]. Thus, at an example time instant 762, legacy STAs 110A-D start a time interval having a duration of at least the EIFS.

After receiving the BAR frame 538 and waiting a time interval 540 having a duration of at least the SIFS, the STA 110A of the illustrated example sends a BA frame 742. However, as compared to the example BA frame 542 of FIG. 5, the example BA frame 742 of FIG. 7 is transmitted such that it can be received by legacy STAs 110A-D. Because the example BA frame 742 is transmitted such that a legacy STAs 110A-D that receives and/or verifies the BA frame 742 can terminate their EIFS intervals at an instant 764 that is substantially coincident with the end of the BA frame 742. After waiting a time interval 766 having a duration of at least DIFS or AIFS[AC], the legacy STAs 110A-D can begin contending for the wireless medium at instant 768. However, if a legacy STA 110A-D is not able to correctly receive the BA frame 742 (e.g., it is a hidden node to the transmitter), the legacy STA 110A-D may start a contention window at the end of its EIFS interval.

Upon expiration of their MAC duration and/or upon receipt of the BA frame 742, non-legacy STAs 110A-D and/or the AP 105 likewise wait the time interval 766, and then begin contending for the wireless medium at substantially the same moment 768 as the legacy STAs 110A-D are able to begin contending for the wireless medium.

While example extended PHY protection mechanism scenarios have been illustrated in FIGS. 5, 6 and 7, persons of ordinary skill in the art will readily understand that many other extended PHY protection mechanism scenarios can be implemented using the methods and apparatus disclosed herein. In particular, the relative lengths of legacy PLCP durations and MAC durations can be controlled and/or set such that in conjunction with any of a variety of last frame scenarios (e.g., the example CF-END frame 548 of FIG. 5, the example BA frame 542 of FIG. 6 and 7, etc.), legacy and/or non-legacy STAs 110A-D and/or the AP 105 can begin contending for the wireless medium at substantially the same moment.

FIG. 8 illustrates an example extended PHY protection mechanism where an initiated transmit operation fails to start. In the example of FIG. 8, a STA 110A to whom the extended PHY protection mechanism is being initiated fails to respond with a CTS frame. To initiate a transmit operation for which an extended PHY protection mechanism will be used, the example AP 105 of FIG. 8 broadcasts the example RTS frame 502. To set the legacy and non-legacy durations for the transmit operation, the example RTS frame 502 of FIG. 8 includes an example MM preamble 504 (e.g., the example MM preamble 402 of FIG. 4A). The example MM preamble 504 of FIG. 8 includes a legacy PLCP length and rate (e.g., the example fields 450 and 455 of FIG. 4B) that represents a PLCP duration 506. In the example of FIG. 8, the PLCP duration 506 has a value that is DELTA 805 longer than the time required to transmit the example RTS frame 502. In some examples, the duration for DELTA 805 is a difference of (a CTS Timeout length 835 plus the DIFS) and the EIFS. Because, in the example of FIG. 8, the CTS frame is not actually transmitted by a STA 110A-D it is not shown in FIG. 8.

Upon receipt of the PLCP duration 506, legacy STAs 110A-D set their PHY_CCA.ind busy duration 507 equal to the PLCP duration 506 as illustrated in FIG. 7. Upon expiration of the example PHY_CCA.ind busy duration 507, legacy STAs 110A-D start a time interval 815 having a duration of at least the EIFS. When the time interval 815 elapses at moment 820, legacy STAs 110A-D are able to contend for the wireless medium (i.e., start a contention window).

Non-legacy STAs 110A-D and/or the AP 105 will wait for a time interval 835 having a duration of at least the CTS Timeout period and then start a time interval 825 having a duration of at least the DIFS. When the example time interval 825 elapses, non-legacy STAs 110A-D and/or the AP 106 may start a contention window at substantially the same time 830 as the legacy STAs 110A-D.

While example extended PHY protection mechanism scenarios have been illustrated in FIGS. 8, persons of ordinary skill in the art will readily understand that many other extended PHY protection mechanism scenarios can be implemented using the methods and apparatus disclosed herein. For instance, the length of a legacy PLCP durations can be controlled and/or set such that, in conjunction with any transmit operation early termination and/or aborts, legacy and/or non-legacy STAs 110A-D and/or the AP 105 can begin contending for the wireless medium at substantially the same moment.

FIGS. 9, 10 and 11 are flowcharts representative of example machine accessible instructions that may be executed to implement the example scenarios of FIGS. 3-8, and/or, more generally, to implement the example MAC 220 of FIGS. 2 and 3. The example machine accessible instructions of FIGS. 9, 10 and/or 11 may be executed by a processor, a controller and/or any other suitable processing device. For example, the example machine accessible instructions of FIGS. 9, 10 and/or 11 may be embodied in coded instructions stored on a tangible medium such as a flash memory, or RAM associated with a processor (e.g., the example processor 225 discussed above in connection with FIG. 2). Alternatively, some or all of the example flowcharts of FIGS. 9, 10 and/or 11 may be implemented using any of a variety of ASIC(s), PLD(s), FPLD(s), discrete logic, hardware, firmware, etc. Also, some or all of the example flowcharts of FIGS. 9, 10 and/or 11 may be implemented manually and/or as any combination of any of the foregoing techniques, for example, a combination of firmware, software and/or hardware. Further, although the example machine accessible instructions of FIGS. 9, 10 and 11 are described with reference to the flowcharts of FIGS. 9, 10 and 11, persons of ordinary skill in the art will readily appreciate that many other methods may be employed to implement the example scenarios of FIGS. 3-8, and/or, more generally, to implement the example MAC 220 of FIGS. 2 and 3. For example, the order of execution of the blocks may be changed, and/or some of the blocks described may be changed, eliminated, sub-divided, or combined. Additionally, persons of ordinary skill in the art will appreciate that the example machine accessible instructions of FIGS. 9, 10 and/or 11 may be carried out sequentially and/or carried out in parallel by, for example, separate processing threads, processors, devices, circuits, etc.

The example machine accessible instructions of FIG. 9 begins with a MAC (e.g., the example MAC 220 of FIGS. 2 and 3 and/or, more particularly, the example extended PHY protection controller 305) setting and/or determining a PLCP legacy duration to be sent in an initiation frame of a transmit operation (e.g., the example RTS frame 502 of FIG. 5) (block 905). Example PLCP legacy duration values for initiation frames are discussed above in connection with FIG. 8. The MAC (e.g., the example header generator 310 and/or the example frame generator 315 of FIG. 3) then creates and sends the initiation frame (block 910). The initiation frame contains a MM preamble including the PLCP legacy length and a MAC duration.

The MAC then waits to receive a response frame (e.g., the example CTS frame 510 of FIG. 5) (block 915). When the response frame is received (block 915), the extended PHY protection controller determines and/or sets the PLCP legacy duration for the next frame of the transmit operation by carrying out, for example, the example machine accessible instructions of FIG. 10 (block 920). The header generator and/or the frame generator then create and send the frame (block 925). The frame includes a MM preamble including the PLCP legacy length and an updated MAC duration.

If there are more frames and/or data to be sent (block 930), control returns to block 920 to sent another frame. If additional frames do not include a MM preamble and/or a PLCP legacy length, control returns to block 925.

In the example of FIG. 9, if there are no more frames and/or data to be sent (block 930), the header generator and/or the frame generator then create and send an acknowledge request frame (e.g., the example BAR frame 538 of FIG. 5) (block 935). The MAC then waits to receive an acknowledge frame (e.g., the example BA frame 542 of FIG. 5) (block 940). When the acknowledge frame is received (block 940), the MAC ends the transmit operation and may start contending for the wireless medium by carrying out, for example, the example machine accessible instructions of FIG. 11 (block 945). Control then exits from the example machine accessible instructions of FIG. 9.

Returning to block 915, if a timeout (e.g., a CTS timeout period) occurs while waiting for the response frame (block 915), the MAC can, as discussed above in connection with FIG. 8, initiate any of a variety of backoff procedures such as those defined in the IEEE 802.11x family of standards before attempting to transmit (block 950). In the illustrated example, the MAC waits a time interval having a duration of at least the DIFS, and then randomly selects a slot of contention window and/or backoff window. When the randomly selected slot arrives, the MAC then attempts to transmit. Control then exits from the example machine accessible instructions of FIG. 9.

The example machine accessible instructions of FIG. 10 begin, for example, when called by the example machine accessible instructions of FIG. 9 at block 920. If the transmit operation is to be terminated with a CF-END frame (e.g., the example scenario of FIG. 5) (block 1005), a MAC (e.g., the example MAC 220 of FIGS. 2 and 3 and/or, more particularly, the example extended PHY protection controller 305) sets the PLCP legacy duration substantially equal to the remaining MAC duration for the transmit operation (block 1010). Control then returns from the example machine accessible instructions of FIG. 10 to, for example, the example machine accessible instructions of FIG. 9 at block 925.

If the transmit operation is not to be terminated with a CF-END frame (e.g., the example scenarios of FIGS. 6 and 7) (block 1005), the extended PHY protection controller sets the MAC duration (block 1015). For example, the MAC duration can be set equal to the remaining length of the transmit operation as discussed in connection with the example of FIG. 7, or the MAC duration can be set longer than the remaining length of the transmit operation as discussed in connection with the example of FIG. 6. The extended PHY protection controller then sets the PLCP legacy duration substantially equal to the MAC duration minus a difference of EIFS and DIFS (block 1020). Control then returns from the example machine accessible instructions of FIG. 10 to, for example, the example machine accessible instructions of FIG. 9 at block 920.

The example machine accessible instructions of FIG. 11 begin, for example, when called by the example machine accessible instructions of FIG. 9 at block 945. If the transmit operation is to be terminated with a CF-END frame (e.g., the example scenario of FIG. 5) (block 1105), a MAC (e.g., the example MAC 220 of FIG. 2) waits a time interval having a duration of at least the SIFS (block 1110) and then the MAC (e.g., the example frame generator 315 of FIG. 3) sends a CF-END frame (e.g., the example CF-END frame 548 of FIG. 5) (block 1115). The MAC then resets its NAV to, for example, zero (0) (block 1120) and then initiates any of a variety of backoff procedures such as those defined in the IEEE 802.11x family of standards before attempting to transmit (block 1125). For example, the MAC waits a time interval having a duration of at least the DIFS, and then randomly selects a slot of contention window and/or backoff window. When the randomly selected slot arrives, the MAC can then attempt to transmit. Control then exits from the example machine accessible instructions of FIG. 10 to, for example, the example machine accessible instructions of FIG. 9 at block 945.

If the transmit operation is not to be terminated with a CF-END frame (e.g., as in the example scenarios of FIGS. 6 and 7) (block 1005), the MAC waits till the end of the MAC duration (block 1130). Control then proceeds to block 1120 to reset the NAV.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
choosing a length field value for a frame header such that, when a transmit operation is ended, a legacy wireless station and a non-legacy wireless station of a wireless local area network are able to start contending for a wireless medium at substantially a same instant; and
sending a frame across the wireless medium that includes the frame header.

2. A method as defined in claim 1, wherein the frame is a physical layer convergence protocol (PLCP) frame comprising a PLCP header, the PLCP header comprising a legacy signal field that includes the length field value.

3. (canceled)

4. A method as defined in claim 2, wherein at least a portion of the PLCP header is decodable by substantially all nodes of the wireless local area network.

5. A method as defined in claim 1, wherein the frame is a request-to-send frame, and the transmit operation is ended when a clear-to-send frame timeout occurs.

6. A method as defined in claim 5, choosing the length field value comprises:
computing a sum of a clear-to-send timeout duration and a distributed inter-frame space;
computing a difference of the sum and an extended inter-frame space; and
adding the difference to a transmit duration for a body of the frame.

7. A method as defined in claim 1, wherein the frame is a first of one or more frames, and the transmit operation is ended when a last of the one or more frames is acknowledged.

8. A method as defined in claim 7, wherein choosing the length field value comprises setting the length field value to a medium access control duration.

9. (canceled)

10. A method as defined in claim 7, wherein choosing the length field value comprises:
computing a difference of an extended inter-frame space and a distributed inter-frame space; and
subtracting the difference from a medium access control duration.

11. (canceled)

12. A method as defined in claim 7, further comprising setting a medium access control duration to a value that is different than a time required to transmit the one or more frames and receive response frame.

13. A method as defined in claim 7, further comprising:
waiting to receive a block acknowledge frame;
waiting a time duration that is at least as long as a short inter-frame spacing after receiving the block acknowledge frame; and
sending a contention-free end frame.

14. A wireless network device comprising:
a wireless modem to transmit a frame via a wireless medium of a wireless network; and
a medium access controller to form the frame, the frame comprising a physical layer convergence protocol (PLCP) header, the PLCP header comprising a legacy signal field that includes a length field value chosen such that, when a transmit operation ends, a legacy wireless station and a non-legacy wireless station of the wireless local area network are permitted to contend for the wireless medium at substantially a same instant.

15. A wireless network device as defined in claim 14, wherein the medium access controller comprises:
an extended physical protection controller to choose the length field value;
a header generator to generate the PLCP header; and
a frame generator to form the frame.

16. A wireless network device as defined in claim 14, wherein wireless modem transmits the frame in accordance with at least one of a past or legacy standard.

17. A wireless network device as defined in claim 14, wherein the frame is a request-to-send frame, and the transmit operation is ended when a clear-to-send frame timeout occurs.

18. (canceled)

19. A wireless network device as defined in claim 14, wherein the frame is a first of one or more frames, and the transmit operation is ended when a last of the one or more frames is acknowledged.

20. A wireless network device as defined in claim 19, wherein the medium access controller chooses the length field value by setting the length field value to a medium access control duration.

21. (canceled)

22. An article of manufacture storing machine accessible instructions which, when executed, cause a machine to:
choose a length field value for a frame header such that, when a transmit operation is ended, a legacy wireless station and a non-legacy wireless station of a wireless local area network are able to start contending for a wireless medium at substantially a same instant; and
send a frame across the wireless medium that includes the frame header.

23. An article of manufacture as defined in claim 22, wherein the machine accessible instructions, when executed, cause the machine to form the frame as a physical layer convergence protocol (PLCP) frame comprising a PLCP header, the PLCP header comprising a legacy signal field that includes the length field value.

24. An article of manufacture as defined in claim 22, wherein the frame is a request-to-send frame, and the transmit operation is ended when a clear-to-send frame timeout occurs, and wherein the machine accessible instructions, when executed, cause the machine to choose the length field value by:
computing a sum of a clear-to-send timeout duration and a distributed inter-frame space;
computing a difference of the sum and an extended inter-frame space; and
adding the difference to a transmit duration for a body of the frame.

25. An article of manufacture as defined in claim 22, wherein the frame is a first of one or more frames, and the transmit operation is ended when a last of the one or more frames is acknowledged.

26-34. (canceled)
